(19) United States
(12) Patent Application Publication
(10) Pub. No.: US 2025/0304511 A1
(43) Pub. Date: Oct. 2, 2025

(54) COAL GANGUE SOIL AMENDMENT, AND PREPARATION METHOD AND USE THEREOF

(71) Applicant: Shandong Jianzhu University, Jinan City (CN)

(72) Inventors: Xiaowei CUI, Jinan City (CN); Zhaojie CUI, Jinan City (CN); Xingxu YU, Jinan City (CN); Huitian DUAN, Jinan City (CN); Wenhan LIU, Jinan City (CN); Kang WANG, Jinan City (CN)

(21) Appl. No.: 19/071,866

(22) Filed: Mar. 6, 2025

(30) Foreign Application Priority Data
Apr. 2, 2024 (CN) 202410393673.1

(51) Int. Cl. C05G 5/40; C05F 3/00; C05F 5/00; C05F 11/08; C05F 17/80; C05G 3/80; C09K 17/20

(52) U.S. Cl. CPC C05G 5/40; C05F 3/00; C05F 5/002; C05F 11/08; C05F 17/80; C05G 3/80; C09K 17/20

(57) ABSTRACT

Provided are a coal gangue soil amendment, and a preparation method and use thereof. The coal gangue soil amendment includes: a crushed coal gangue material, a crushed cornstalk material, a livestock manure, a compound microbial agent, and a water-absorbing and water-retaining particle, with a weight ratio of the crushed coal gangue material, the crushed cornstalk material, the livestock manure, the compound microbial agent, and the high molecular water-absorbing and water-retaining particle being 50:20:5:3:1, where the coal gangue soil amendment is applied to soil at a weight ratio of 5 g/kg.

### CROSS REFERENCE TO RELATED APPLICATION

This patent application claims the benefit and priority of Chinese Patent Application No. 202410393673. 1 filed with the China National Intellectual Property Administration on Apr. 2, 2024, the disclosure of which is incorporated by reference herein in its entirety as part of the present application.

### TECHNICAL FIELD

The present disclosure relates to the technical field of soil amendments, and in particular to a coal gangue soil amendment, and a preparation method and use thereof.

### BACKGROUND

Currently, the decline of soil fertility of cultivated land is a widespread problem in agricultural production, which has become the main obstacle to crop growth demand. Fully utilizing various industrial and agricultural wastes rich in organic matter and nutrients to improve soil is not only of great significance for agricultural production but also can reduce the pollution load of the wastes on the environment. Currently, the development of improvement for barren soil is gradually receiving widespread attention.

Coal gangue is a waste generated during coal mining and processing. It is currently one of the largest industrial solid wastes in terms of emissions. With the continuous development of the mining industry, the annual increase in coal gangue in China is about 10% to 15% of the coal output, and the cumulated stockpile has reached over 5 billion tons at present. The accumulation of coal gangue not only pollutes the environment, but also occupies a large area of land and is prone to geological disasters such as landslides, causing serious ecological damage and heavy losses to people's lives and property safety. Therefore, it is very necessary to carry out waste reduction disposal and resource utilization of coal gangue.

### SUMMARY

To solve the technical problems described above, the present disclosure provides a coal gangue soil amendment, and a preparation method and use thereof, which aims at achieving significant nutrient improvement of barren soils by using coal gangue and other inexpensive and readily available industrial and agricultural solid wastes as raw materials with a concise formula, as a soil amendment for nutrient improvement of barren soils.

The present disclosure provides a coal gangue soil amendment, including the following main components: a crushed coal gangue material, a crushed cornstalk material, a livestock manure, a compound microbial agent, and a water-absorbing and water-retaining particle, with a weight ratio of the crushed coal gangue material, the crushed cornstalk material, the livestock manure, the compound microbial agent, and the high molecular water-absorbing and water-retaining particle being 50:20:5:3:1,
where the coal gangue soil amendment is applied to soil at a weight ratio of 5 g/kg.

In some embodiments, the crushed coal gangue material is in a form of a powder passing through a 20-mesh sieve.

In some embodiments, the crushed cornstalk material is in a form of a powder passing through a 20-mesh sieve.

In some embodiments, the livestock manure is an organic chicken manure fertilizer prepared by rotting and fermenting chicken manure and then sterilizing a resulting material at a high temperature; and the sterilizing is conducted at a temperature of 120° C.

In some embodiments, the water-absorbing and water-retaining particle is a polyacrylamide with a particle size of 60 meshes to 80 meshes.

In some embodiments, the compound microbial agent is a mixture of Bacillus megaterium, Bacillus licheniformis, and Bacillus subtilis, mixed in a volume ratio of the Bacillus megaterium, the Bacillus licheniformis, and the Bacillus subtilis of 1:1:1, with an effective live bacterial concentration of 3.6×10⁷ CFU/mL for each bacterium.

The present disclosure further provides a method for preparing the coal gangue soil amendment as described above, including:
step 1, according to the fact that a land to be applied is a backfilled agricultural land in a coal mining subsidence area, selecting coal gangue, cornstalks, and chicken manure, which are abundant solid wastes found in the land, and subjecting a resulting selected material to a treatment to obtain main components of the coal gangue soil amendment;
step 2, crushing the coal gangue and the cornstalks to a particle size of 20 meshes to obtain the crushed coal gangue material and the crushed cornstalk material; and fermenting the livestock manure to obtain an organic fertilizer;
step 3, mixing the crushed coal gangue material, the crushed cornstalk material, the organic fertilizer, the water-absorbing and water-retaining particle, and the compound microbial agent in a weight ratio of 50:20:5:3:1 to obtain an amendment; and
step 4, applying the amendment obtained in step 3 to soil at the weight ratio of of 5 g/kg.

The present disclosure further provides use of a coal gangue soil amendment for nutrient improvement of barren soil. The use includes using the coal gangue soil amendment defined in step 3 for ecological restoration of a land selected from the group consisting of a backfilled land in a coal mining subsidence area and a saline-alkali land, with the coal gangue soil amendment used at an amount of 500 kg/mu.

Compared with the related technology, the coal gangue soil amendment, and the preparation method and the use thereof in some embodiments of the present disclosure have the following beneficial effects.

The present disclosure provides a coal gangue soil amendment, and a preparation method and use thereof:

1. In the present disclosure, coal gangue, a byproduct of coal mining, is used as the main material for the amendment, which can provide a solution to the problems of large storage capacity and poor utilization effect of coal gangue.

2. In the present disclosure, agricultural solid wastes such as cornstalks and livestock manure are also used as the main materials for the amendment. The materials have the advantages of low cost, easy availability, and simple processing and production processes. Currently, a large amount of agricultural solid waste is produced in China every year, creating a substantial processing demand. Thus, the promotion of the present disclosure can promote the treatment and reuse of agricultural solid wastes.

3. The compound microbial agent is composed of Bacillus megaterium, Bacillus licheniformis, and Bacillus subtilis, which are widely distributed in the soil and plants of mining areas and can effectively promote the fermentation and activation of coal gangue powder, promote plant growth, and improve physical and chemical properties of soils. The various strains of the compound microbial agent can work synergistically with each other to prolong the duration of the effect and achieve long-term soil enhancement and restoration.

4. The soil amendment formulated by the method is designed to improve characteristics, such as low nutrient content, high soil salt content, poor soil structure, and poor water retention of backfilled soil in a coal mining subsidence area. After applying the amendment, the soil nutrient content is increased, the soil aggregate level is increased, and the crop growth is significantly improved, thereby achieving nutrient enhancement of barren soils.

5. The coal gangue soil amendment shows a simple preparation process and inexpensive and readily available raw materials and is environmentally friendly and conducive to large-scale promotion and use.

### DETAILED DESCRIPTION OF THE EMBODIMENTS

Unless otherwise defined, all technical and scientific terms used herein shall have the same meanings as commonly understood by those skilled in the art to which the present disclosure belongs. The terms used in the specification of the present disclosure are merely for the purpose of describing specific embodiments, but are not intended to limit the present disclosure.

The present disclosure provides a coal gangue soil amendment, including the following components: a crushed coal gangue material, a crushed cornstalk material, a livestock manure, a compound microbial agent, and a high molecular water-absorbing and water-retaining particle, with a weight ratio of the crushed coal gangue material, the crushed cornstalk material, the livestock manure, the compound microbial agent, and the high molecular water-absorbing and water-retaining particle being50:20:5:3:1,
where the coal gangue soil amendment is applied to soil at a weight ratio of 5 g/kg.

The following examples are provided for the purpose of explaining the present disclosure and do not constitute a limitation on the scope of the claims. Other alternative means that can be conceived by those skilled in the art based on the content of the specification should fall within the scope of the claims of the present disclosure.

In the following examples, the coal gangue was available from Shandong Xinjulong Energy Co., Ltd., China, with a particle size of about 2 mm and constituent elements shown below; the cornstalks were available from a farmland in Jining City, Shandong Province, China, which were washed, naturally aired, and crushed (sieved through a 20-mesh sieve) for future use; the chicken manure fertilizer was a commercially available material purchased from a company in Shandong Province, China; and polyacrylamide is purchased from Shanghai Macklin Biochemical Technology Co., Ltd., China.

TABLE 1
Constituent elements of coal gangue

| | | | Risk screening values for soil |
|---|---|---|---|
| | | | contamination of agricultural |
| Element | Unit | Content | land |
| Si | | 242.1 | |
| Al | | 101. 3 | |
| Fe | | 28.7 | |
| K | g · kg⁻¹ | 21.8 | / |
| Mg | | 9.00 | |
| Na | | 8.44 | |
| Ca | | 7.29 | |
| Ti | | 4.24 | |
| Total cadmium | | 0.090 | 0.3 |
| Total mercury | | 0.092 | 2.4 |
| Total arsenic | | 0.322 | 30 |
| Total lead | mg · kg⁻¹ | 25.2 | 120 |
| Total chromium | | 74.5 | 200 |
| Total copper | | 28.0 | 100 |
| Total nickel | | 26. 8 | 100 |
| Total zinc | | 61.6 | 250 |

In the following examples, the compound microbial agent was prepared by a method as follows:

S1. Activation and propagation of Bacillus subtilis, Bacillus megaterium, and Bacillus licheniformis:
first, the Bacillus subtilis, the Bacillus megaterium, and the Bacillus licheniformis were inoculated onto an inclined surface of a beef-extract peptone medium, respectively, and incubated at a temperature of 28° C. to 30° C. for 48 h to 50 h and activated; then, a resulting activated test strains were respectively inoculated into LB liquid mediums and shaken on a constant temperature incubator shaker at a temperature of 36° C. to 38° C. and 90 rpm to 120 rpm for 12 h to 14 h for propagation to obtain bacterial solutions; and the bacterial solutions were diluted with sterile water to 3.6×10⁷ CFU/mL (counted using a hemocytometer). The compound microbial agent was composed of the Bacillus subtilis, the Bacillus megaterium, and the Bacillus licheniformis, each with an effective concentration of 3.6×10⁷ CFU/mL, mixed in a volume ratio of 1:1:1.

S2. The components of the beef-extract peptone medium and the preparation steps thereof were as follows:

3.0 g of a beef extract, 10.0 g of peptone, 5.0 g of sodium chloride, and 20.0 g of an agar were adjusted to pH 7.5 and mixed, a resulting mixture was diluted to volume of 1000 mL with distilled water, and a resulting material was sterilized at 121′ C for 30 min to obtain the beef-extract peptone medium.

The components of the LB liquid medium and the preparation steps thereof were as follows:

10.0 g of tryptone, 5.0 g of a yeast extract, and 10.0 g of sodium chloride were mixed, a resulting mixture was diluted to volume of 1000 mL with distilled water, a resulting product was adjusted to pH 7.2, and a resulting material was sterilized at 121° C. for 30 min to obtain the LB liquid medium.

### Example 1

### Example of Plant Potting

Experimental object: by using laboratory pot experiments with corn as an indicator crop and barren soil as a experimental soil, the effects of the prepared soil amendment on crop growth and soil nutrients were studied.

Experimental method and treatment: 0 to 20 cm deep barren soil taken from the Dongying Junmachang land in China was air-dried and then sieved by a 2 mm sieve as experimental soil. The basic soil data were as follows: pH=7.50, 7.19 g·kg⁻¹ of organic matter, 63.35 mg·· kg⁻¹ of alkaline hydrolyzable nitrogen, 4.01 mg··kg⁻¹ of available phosphorus, and 105.6 mg··kg⁻¹ of available potassium. In the experiment, a bottom-perforated plastic flowerpot with an inner diameter of 20 cm and a height of 20 cm was used. To prevent soil leakage, a layer of 200-mesh gauze was placed at the bottom of the flowerpot. Three treatments were set, each with three parallel experiments. For each experimental group, 1.5 kg of dry soil was added to the flowerpot; after watering, the flowerpot was equilibrated for 7 days; and three pre-treated corn seeds were sown in each flowerpot, evenly distributed in 1 cm deep holes, covered with soil, and exposed to light for 10 h per day. After 30 days of cultivation, an appropriate amount of soil and corn plants were taken to measure the corresponding indicators.

Treatment 1, CK: control check.

Treatment 2, P1: a crushed coal gangue material, a crushed cornstalk material, and a chicken manure fertilizer (in a mass ratio of 50:20:5, with a total application amount of 5 g··kg⁻¹).

Treatment 3, P2: a crushed coal gangue material, a crushed cornstalk material, a chicken manure fertilizer, polyacrylamide, and a compound microbial agent (in a mass ratio of 50:20:5:3:1, with a total application amount of 5 g··kg⁻¹).

### Experimental Results

With reference to Table 2, the present disclosure has significant promotion and improvement effects on crop plant height and nutrient content in soil, among which the effect of P2 group is the most significant.

Compared with the control group, in P1, the plant height increases by 17.62%, the total nitrogen content increases by 27.08%, the content of available phosphorus decreases by 5.48%, the content of rapidly available potassium increases by 2.81%, and the content of organic matter increases by 50.83%; and compared with the control group, in P2, the plant height increases by 27.51%, the total nitrogen content increases by 43.75%, the content of available phosphorus increases by 12.03%, the content of rapidly available potassium increases by 8.17%, and the content of organic matter increases by 72.24%.

TABLE 2
Effect of soil amendment on crop plant height and contents of nitrogen, phosphorus, potassium, and
organic matter in soil

| | | | | Content of | |
|---|---|---|---|---|---|
| | | Total | Content of | rapidly | Content of |
| | | nitrogen | available | available | organic |
| | Plant | content | phosphorus | potassium | matter |
| Treatment | height (cm) | (mg/kg) | (mg/kg) | (g/kg) | (g/kg) |
| CK | 23.27 ± 0.70 | 448.0 ± 22.9 | 28.90 ± 2.67 | 0.306 ± 0.0007 | 25.62 ± 1.67 |
| P1 | 27.37 ± 0.71 | 569.3 ± 63.0 | 27.31 ± 3.85 | 0.315 ± 0.0157 | 38.64 ± 3.17 |
| P2 | 29.67 ± 0.36 | 644 ± 23.0 | 32.37 ± 4.25 | 0.331 ± 0.0046 | 44.13 ± 2.07 |

### Experimental Conclusion

The growth of corn planted under P2 treatment is the best, and the content of various nutrients in the soil has been significantly improved, indicating that the amendment has a significant effect on soil improvement.

### Example 2

Experimental object: by using field planting experiments with wheat as an indicator crop, a planting experiment was carried out in a backfilled zone of a coal mining subsidence area to study the effect of the prepared soil amendment on crop growth and soil nutrients in the backfilled barren land in the coal mining subsidence area.

Experimental method and treatment: According to a ratio of 20 kg of a cornstalk powder, 50 kg of coal gangue, 5 kg of an organic fertilizer, 3 kg of a polyacrylamide particle, and 1000 mL of a sprayed compound microbial agent per 100 square meters of soil, the materials were applied to the backfilled land plot in the coal mining subsidence area of Xinjulong coal mine in Juye County, Heze City, Shandong Province, China. A plot area was 100 square meters. The compound microbial agent was composed of Bacillus subtilis, Bacillus megaterium, and Bacillus licheniformis, each with an effective concentration of 3.6×10⁷ CFU/mL, mixed in a volume ratio of 1:1:1. The amendment was evenly mixed with 20 cm deep tillage soil, followed by flood irrigation, and then a resulting irrigated soil was equilibrated for 7 days. A plot in this area with the same area and no amendment was selected as a control group. Wheat seeds were sown in both plots at the same density, covered with soil, and cultivated for 28 days. After cultivation, an appropriate amount of soil and wheat plants were taken to measure the corresponding indicators.

Experimental results: With reference to Table 3.1 and Table 3.2, the example of the present disclosure shows significant promotion effects on crop growth and the improvement of nutrient content in the soil.

Compared with the control group, in the soil of this example, the total nitrogen content increases by 27.08%, the content of available phosphorus increases by 1.42%, the content of rapidly available potassium increases by 2.94%, and the content of organic matter increases by 50.82%. For the planted wheat plants, the plant height increases by 29.31%, the root length increases by 12.03%, the fresh weight increases by 14.02%, and the dry weight increases by 14.29%.

TABLE 3.1
Effect of soil amendment on nutrient content of backfilled
soil in mining areas

| | | | Content of | |
|---|---|---|---|---|
| | Total | Content of | rapidly | Content of |
| | nitrogen | available | available | organic |
| | content | phosphorus | potassium | matter |
| Treatment | (mg/kg) | (mg/kg) | (g/kg) | (g/kg) |
| CK | 448.0 ± 22.9 | 28.90 ± 2.67 | 0.306 ± 0.0007 | 25.62 ± 1.67 |
| Example | 569.3 ± 63.0 | 27.31 ± 3.85 | 0.315 ± 0.0157 | 38.64 ± 3.17 |

TABLE 3.2
Effect of soil amendment on wheat growth

| | | | Biomass | |
|---|---|---|---|---|
| | Plant | Root length | Fresh weight | Dry weight |
| Treatment | height (cm) | (cm) | (g) | (g) |
| CK | 14.4 ± 2.4 | 56.8 ± 6.7 | 10.7 ± 0.7 | 0.56 ± 0.020 |
| Example | 22.5 ± 0.9 | 64.2 ± 8.5 | 12.2 ± 0.5 | 0.64 ± 0.017 |

### Experimental Conclusion

The application of the soil amendment of the present disclosure significantly increases the content of various nutrients in the soil, thus promoting crop growth. This suggests that the amendment has a considerable effect on soil improvement. The soil amendment of the present disclosure not only can improve the physical and chemical properties of soil, such as the content of nitrogen, phosphorus, potassium, and organic matter, but also can significantly promote the growth of crops.

The foregoing is merely the embodiments of the present disclosure and is not intended to limit the scope of the present disclosure. Any equivalent structure or equivalent procedure variations made based on the description of the present disclosure and the direct or indirect application thereof in other related technical fields should be fell within the scope of the present disclosure.

What is claimed is:

1. A coal gangue soil amendment, comprising the following main components:
a crushed coal gangue material, a crushed cornstalk material, a livestock manure, a compound microbial agent, and a water-absorbing and water-retaining particle, with a weight ratio of the crushed coal gangue material, the crushed cornstalk material, the livestock manure, the compound microbial agent, and the high molecular water-absorbing and water-retaining particle being 50:20:5:3:1,
wherein the coal gangue soil amendment is applied to soil at a weight ratio of 5 g/kg.

2. The coal gangue soil amendment of claim 1, wherein the crushed coal gangue material is in a form of a powder passing through a 20-mesh sieve.

3. The coal gangue soil amendment of claim 1, wherein the crushed cornstalk material is in a form of a powder passing through a 20-mesh sieve.

4. The coal gangue soil amendment of claim 1, wherein the livestock manure is an organic chicken manure fertilizer prepared by rotting and fermenting chicken manure and then sterilizing a resulting material at a high temperature.

5. The coal gangue soil amendment of claim 1, wherein the water-absorbing and water-retaining particle is a polyacrylamide with a particle size of 60 meshes to 80 meshes.

6. The coal gangue soil amendment of claim 1, wherein the compound microbial agent is a mixture of Bacillus megaterium, Bacillus licheniformis, and Bacillus subtilis, mixed in a volume ratio of the Bacillus megaterium, the Bacillus licheniformis, and the Bacillus subtilis of 1:1:1, with an effective live bacterial concentration of 3.6×10⁷ CFU/mL for each bacterium.

7. A method for preparing the coal gangue soil amendment of claim 1, comprising:
step 1, according to the fact that a land to be applied is a backfilled agricultural land in a coal mining subsidence area, selecting coal gangue, cornstalks, and chicken manure, which are abundant solid wastes found in the land, and subjecting a resulting selected material to a treatment to obtain main components of the coal gangue soil amendment;
step 2, crushing the coal gangue and the cornstalks to a particle size of 20 meshes to obtain the crushed coal gangue material and the crushed cornstalk material; and fermenting the livestock manure to obtain an organic fertilizer;
step 3, mixing the crushed coal gangue material, the crushed cornstalk material, the organic fertilizer, the water-absorbing and water-retaining particle, and the compound microbial agent in a weight ratio of 50:20:5:3:1 to obtain an amendment; and
step 4, applying the amendment obtained in step 3 to soil at the weight ratio of 5 g/kg.

8. A method for using the coal gangue soil amendment of claim 1, comprising:
using the coal gangue soil amendment for ecological restoration of a land selected from the group consisting of a backfilled land in a coal mining subsidence area and a saline-alkali land, with the coal gangue soil amendment used at an amount of 500 kg/mu.

9. The method of claim 7, wherein the crushed coal gangue material is in a form of a powder passing through a 20-mesh sieve.

10. The method of claim 7, wherein the crushed cornstalk material is in a form of a powder passing through a 20-mesh sieve.

11. The method of claim 7, wherein the livestock manure is an organic chicken manure fertilizer prepared by rotting and fermenting chicken manure and then sterilizing a resulting material at a high temperature.

12. The method of claim 7, wherein the water-absorbing and water-retaining particle is a polyacrylamide with a particle size of 60 meshes to 80 meshes.

13. The method of claim 7, wherein the compound microbial agent is a mixture of Bacillus megaterium, Bacillus licheniformis, and Bacillus subtilis, mixed in a volume ratio of the Bacillus megaterium, the Bacillus licheniformis, and the Bacillus subtilis of 1:1:1, with an effective live bacterial concentration of 3.6×10⁷ CFU/mL for each bacterium.
